(19) United States
(12) Patent Application Publication
(10) Pub. No.: US 2025/0222771 A1
(43) Pub. Date: Jul. 10, 2025

(54) METHOD FOR DISPLAYING EXTENDED IMAGES, SYSTEM, COMPUTER PROGRAM, AND VEHICLE THEREFOR

(71) Applicant: FSVAP Europe, Paris (FR)

(72) Inventors: Jean-Baptiste TROLLE, Paris (FR); Sébastien MEYER, Paris (FR); Fubin ZHU, XIAMEN (CN); Eric AUBEPART, Paris (FR)

(21) Appl. No.: 19/012,495

(22) Filed: Jan. 7, 2025

(30) Foreign Application Priority Data
Jan. 8, 2024 (FR) FR 2400163

(51) Int. Cl. B60K 35/28; G06V 20/56; G06V 20/59; G06V 40/18

(52) U.S. Cl. CPC B60K 35/28; G06V 20/56; G06V 20/597; G06V 40/18; B60K 2360/149; B60K 2360/171; B60K 2360/176

(57) ABSTRACT

A system and method for displaying extended images of a low front end of a vehicle having a front hood, each extended image including an area visible to a user of the vehicle and an area concealed by the front hood of the vehicle, the vehicle being equipped with at least one exterior camera having a field of view oriented towards the low front end of the vehicle. The method carried out by the system includes the steps of: estimating a position of the vehicle user's eyes, processing images captured by the exterior camera to obtain extended images of the low front end of the vehicle; implementing a superimposition, on each image captured, of a representation of an outline of the front hood of the vehicle, the representation being dependent on the position of the eyes of the user, and displaying the extended images on an on-board display device.

### TECHNICAL FIELD

The present invention relates to a method for displaying extended images of a low front end of a vehicle having a front hood, each extended image comprising an area visible to a user of the vehicle and an area concealed by the vehicle's front hood.

The invention also relates to a system for displaying extended images of a low front end of an associated vehicle, an associated computer program, and an associated vehicle.

The invention lies in the field of vehicles, in particular motor vehicles, equipped with enhanced functionalities, in particular to increase safety and user satisfaction.

### BACKGROUND

An increasing number of motor vehicles are equipped with exterior cameras, which can provide driving assistance, in particular for viewing concealed areas or blind spots, thus helping to avoid collisions or prevent damage to the motor vehicle while handling.

In particular, motor vehicles are known to be equipped with a front hood, which is therefore located at the low front end of the vehicle and blocks visibility of an area at the low front end of the vehicle, which is thus obscured. Such a concealed area prevents a vehicle user, e.g. the driver, from viewing low obstacles, whether fixed objects or moving obstacles, e.g. small animals. Depending on the situation, this lack of visibility can lead to collisions or accidents.

There is therefore a need to improve the visibility of areas at the low front end of the motor vehicle, in particular areas hidden by the presence of the front hood.

One known solution to this problem is to display images captured by an exterior camera placed outside the vehicle, whose field of view captures the low front end of the vehicle. However, viewing the real image of the vehicle's low front end, comprising the area visible only to the user, at the same time as images captured by an exterior camera requires an effort on the part of the user to reconcile the two views, and is therefore not always satisfactory in terms of comfort and reduction of cognitive load.

Complex image processing solutions are also known, involving the storage of images captured by multiple exterior cameras to calculate images of concealed areas. Such solutions require the addition of hardware components, such as computing processors and memory, and are therefore costly.

### SUMMARY

One aim of the invention is to provide a method and a system for displaying extended images, enabling the user to view an area concealed by the vehicle's front hood, which consumes fewer hardware resources while providing comfort and an improved user experience.

To this end, it is an object of the invention to provide a method for displaying extended images of a low front end of a vehicle having a front hood, each extended image comprising an area visible to a user of the vehicle and an area concealed by the front hood of the vehicle, said vehicle being equipped with at least one exterior camera having a field of view oriented towards the low front end of said vehicle, and including said visible area and concealed area, the method being implemented by a computing processor of an on-board programmable electronic device connected to said at least one exterior camera. The method carried out by the system comprises steps of:
estimating a position of the vehicle user's eyes,
processing images captured by said at least one exterior camera to obtain extended images of the low front end of the vehicle, implementing a superimposition, on each image captured by said at least one exterior camera, of a representation of an outline of the front hood of the vehicle, said representation being produced as a function of said position of the eyes of the user of the vehicle, and
displaying said extended images on an on-board display device.

Advantageously, the proposed process only requires one or more exterior cameras located at the low front end of the vehicle and a conventional computing processor, which does not require the addition of expensive hardware resources. In addition, superimposing a representation of the outline of the vehicle's front hood according to the position of the user's eyes helps the user to visualize the border between the area concealed by the hood and the visible area, and thus to find their way around spatially and understand the environment without any particular cognitive effort. This enhances user comfort and experience.

According to other advantageous aspects of the invention, the method for displaying extended images of a low front end of a vehicle comprises one or more of the following features, taken alone or in any technically feasible combination.
The processing calculates said representation of the outline of the vehicle's front hood, additionally using previously stored information relating to the vehicle model
The position of the user's eyes is predetermined and previously recorded.
The method is implemented in a vehicle further comprising an interior camera oriented towards the interior of the vehicle, the estimating of a position of the user's eyes comprising determining the position of the user's eyes using images captured by said interior camera.
The method further comprises a step of correcting said extended images to obtain corrected extended images prior to the display step, the correction step being configured to transform said field of view of said at least one camera into a user's field of view according to said position of the user's eyes

The invention further relates to a system for displaying extended images of a low front end of a vehicle having a front hood, each extended image comprising an area visible to a user of the vehicle and an area concealed by the front hood of the vehicle, said vehicle being equipped with at least one exterior camera having a field of view oriented towards the low front end of said vehicle, and including said visible area and concealed area, the method being implemented by a computing processor of an on-board programmable electronic device connected to said at least one exterior camera. This system is such that the computing processor is configured to implement:
a module for estimating a position of the vehicle user's eyes,
a module for processing images captured by said at least one camera to obtain extended images of the low front end of the vehicle, implementing a superimposition, on each image captured by said at least one camera, of a representation of an outline of the front hood of the vehicle, said representation being produced as a function of said position of the eyes of the user of the vehicle, and
a module for displaying said extended images on an on-board display device.

According to some embodiments, the processing module calculates said representation of the outline of the vehicle's front hood, additionally using previously stored information relating to the vehicle model.

According to one or more other embodiments, the system further comprises an interior camera oriented towards an interior of the vehicle, the module for estimating a position of the user's eyes implementing a determination of the position of the user's eyes using images captured by said interior camera.

According to various embodiments, the on-board display device is a display screen arranged on a dashboard of said vehicle.

The invention further relates to a non-transitory, computer-readable medium having stored thereon computer program comprising software instructions which, when executed by a computer, implement a method for displaying extended images of a low front end of a vehicle as defined above.

The invention further relates to a vehicle comprising a system for displaying extended images of a low front end of a vehicle as defined above.

### BRIEF DESCRIPTION OF THE DRAWINGS

The invention will become clearer on reading the following description, given solely by way of non-limiting example, and made with reference to the drawings, wherein:

FIG. 1 is a schematic illustration of a motor vehicle equipped with a system for displaying extended images;

FIG. 2 shows a schematic representation of a system for displaying extended images according to one embodiment; and

FIG. 3 is a diagram of the main steps of a method for displaying extended images according to one embodiment.

### DETAILED DESCRIPTION OF THE DRAWINGS

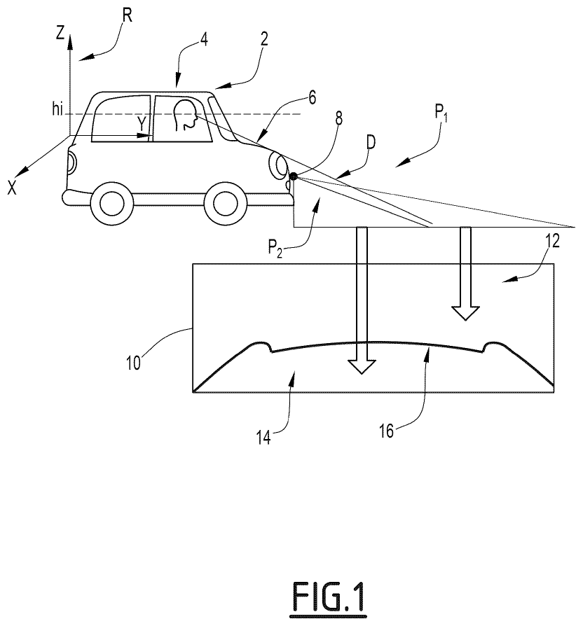

A motor vehicle 2 and a user 4 of the motor vehicle, for example the driver of the motor vehicle, are shown schematically in FIG. 1.

In the following description, we will refer to the vehicle 2.

The vehicle 2 is associated with a three-dimensional reference frame R consisting of three axes (X, Y, Z) perpendicular to each other. The eyes of the user 4 are located at a height hi in the reference frame R, the height hi being considered to be the position of the eyes of the user 4, making it possible to define a direction D delimiting a spatial area P1 visible to the user at the low front end of the vehicle. The visible area P1 is delimited by the front hood 6 of the vehicle 2. In other words, direction D delimits the user's viewing angle. Direction D is represented, for example, by a vector in the three-dimensional reference frame R.

A further spatial area P2, also located at the low front end of vehicle 2, is an area concealed by the front hood 6 of the vehicle 2.

The vehicle 2 is also equipped with an exterior camera 8, or several exterior cameras not shown in the figures, with a field of view directed towards the low front end of the vehicle. The exterior camera 8 is adapted to capture images including a area visible 12 to the user 4 (corresponding to the spatial area P1 in the captured image) and an area concealed 14 by the front cover 6 (corresponding to the spatial area P2 in the captured image).

In addition, the illustrated embodiment of the invention advantageously includes the display of extended images 10, formed from the images captured by the exterior camera 8 and additionally including, superimposed, a representation of an outline 16 of the front hood 6 of the vehicle 2. This representation is a function of the position of the user's eyes, and therefore of direction D. In other words, the outline 16 of the hood superimposed on each extended image 10 is a representation of the outline of the front hood 6 as seen by the user 4 of the vehicle 2. By way of example, the outline 16 is represented by a smooth curve with a color, preferably with a green color, and the width of the smooth curve is predefined or modifiable by the user.

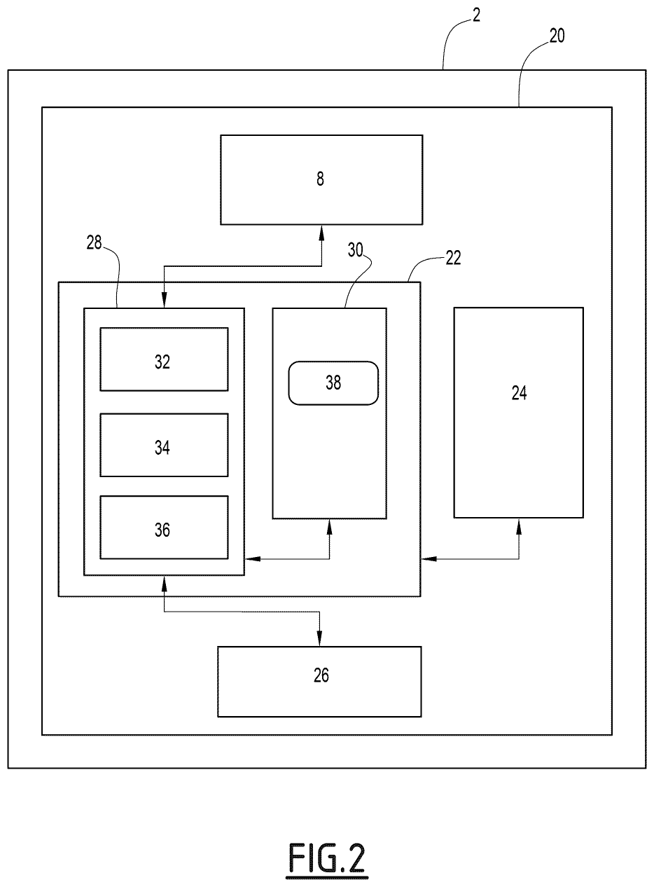

FIG. 2 schematically shows a system 20 for displaying extended images of a low front end of a vehicle 2.

The system 20 is installed in a vehicle, such as a motor vehicle.

The system 20 comprises a first camera 8, which is an exterior camera, with a field of view directed towards the low front end of the vehicle 2.

According to the variants, multiple exterior cameras 8 are positioned at the low front end of the vehicle 2, so as to capture a wider field of view by combining the fields of view of each exterior camera.

The exterior camera 8 is connected to an on-board programmable electronic device 22 forming part of the system 20.

The programmable electronic device 22 comprises or is connected to an on-board display device 24.

For example, the display device 24 is a display screen arranged on a dashboard (not shown) of the vehicle 2.

Optionally, the vehicle 2 further comprises an interior camera 26, positioned inside the vehicle's passenger compartment and oriented towards the interior of the vehicle's passenger compartment.

The interior camera 26 is associated with or comprises a unit for determining the position of the eyes of a user 4 of the vehicle 2. In this way, the position of the user's eyes can be determined in real time, and this eye position information is used to dynamically determine the vehicle's outline position.

For example, the interior camera 26 is part of a DMS (Driver Monitoring System) connected to the on-board programmable electronic device 22.

The on-board programmable electronic device 22 is, for example, an on-board electronic computing unit ECU, and comprises at least one computing processor 28 and an electronic memory unit 30.

The on-board programmable electronic device 22 comprises:
a module 32 for estimating a position of the vehicle user's eyes,
a module 34 for processing images captured by the exterior camera 8 to obtain extended images of the low front end of the vehicle, implementing a superimposition, on each image captured by said camera, of a representation of an outline of the front hood of the vehicle, the representation being produced as a function of said position of the eyes of the user of the vehicle,
a module 36 for displaying extended images on the on-board display device 24.

For example, the position of the driver's eyes is expressed as a height in the spatial reference frame R associated with the vehicle.

If an interior camera 26 is present, the module 32 is configured to estimate a position of the user's eyes from images provided by interior camera 26.

Preferably, the electronic memory unit 30 is configured to store information 38 relating to the model of the vehicle 2, this information 38 comprising in particular information relating to the shape of the vehicle 2, this information being in particular usable to generate the outline of the front hood of the vehicle which is represented in the extended images.

Preferably, the extended images are displayed substantially in real time following the capture of images by the exterior camera 8, advantageously enabling the user 4 to view the extended images of the low front end of the vehicle in real time, including the concealed area.

The computing processor 28 is configured to implement modules 32, 34, 36 when the programmable electronic device 22 is powered up.

In one embodiment, the modules 32, 34, 36 are made in the form of software instructions forming a computer program, which, when executed by a computer, implements a method for displaying extended images.

The computer program comprising software instructions is furthermore recorded on a non-transitory, computer-readable medium. The computer-readable medium is for example a medium able to store the electronic instructions and to be coupled to a bus of a computer system. As an example, the readable medium is an optical disc, a magneto-optical disc, a ROM memory, a RAM memory, any type of non-volatile memory (for example EPROM, EEPROM, FLASH, NVRAM), a magnetic card or an optical card.

In a variant not shown, the modules 32, 34, 36 are each made in the form of programmable logic components, such as FPGAs (Field-Programmable Gate Arrays), microprocessors, GPGPU components (General-Purpose Processing on Graphics Processing), or dedicated integrated circuits, such as ASICs (Application-Specific Integrated Circuits).

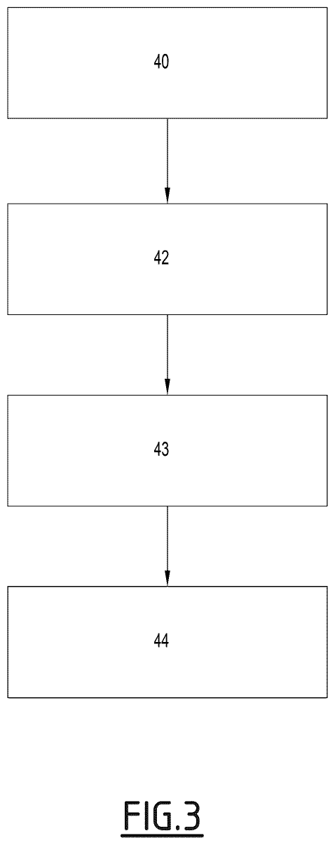

FIG. 3 is a diagram of the main steps of an embodiment of the method for displaying extended images of the low front end of a vehicle implemented by the extended image display system 20.

The process comprises a step 40 for estimating the position of the vehicle user's eyes.

The position of the vehicle's eyes is preferably expressed in a three-dimensional reference frame associated with the vehicle, for example the reference frame R.

According to a first variant, the eye position is a fixed, previously stored position. For example, the fixed position is an average position estimated for all users, making a fixed angle between the projection direction D and the ground, the fixed angle being a predefined value between 20° and 45° depending on the vehicle model.

In other words, the estimated eye position is fixed in this embodiment for a given vehicle model, and is read from a memory in step 40.

According to a second variant, when the vehicle is equipped with an interior camera, the estimated eye position is calculated from images captured by the interior camera.

The estimated eye position is then used to calculate the projection, with the direction D delimiting the portion of the vehicle's low front end visible to the user, the direction D being a function of the user's eye position, as is clear from the representation in [FIG. 1].

The method then comprises a step 42 for processing the images captured by the exterior camera.

For each image captured by the exterior camera, the processing comprises superimposing an outline of the vehicle's front hood. The outline representation is a function of the position of the driver's eyes, and more specifically a function of the direction D delimiting the portion of the vehicle's low front end visible to the user. In fact, the outline representation is positioned along the projection in the direction D within the image captured by the exterior camera.

Preferably, the shape of the hood outline is calculated on the basis of vehicle model information, so as to realistically represent a silhouette of the vehicle 2.

For example, hood outline shapes are pre-calculated and stored, based on vehicle model and user eye positions.

Advantageously, the step 42 is fast and consumes few computing resources.

For example, the outline representation is drawn, for example as a colored line, on the image captured by the exterior camera. Preferably, the colored line is a smooth curve with a green color or with multiple colors, and the width of the smooth curve is predefined according to the vehicle model or can be modified by the user.

Advantageously, the outline represented in this way enables the user to determine easily and without cognitive effort which part of the extended image comprises the area realistically concealed by the vehicle hood.

According to an optional variant, the processing 42 additionally comprises a realignment, making it possible to obtain, from first images obtained by the exterior camera, second images recentered with respect to the position of the user's eyes. Extended images are then obtained by representing the outline of the vehicle's front hood on the refocused second images. Advantageously, the extended images thus obtained correspond to the user's eye position.

The method then comprises a step 44 for displaying the extended image thus obtained on a selected on-board display device.

Optionally, the method comprises a step of correcting 43 said extended images to obtain corrected extended images prior to the display step 44, the correction step 43 being configured to transform said field of view of said at least one camera into a user's field of view according to said position of the user's eyes.

Advantageously, the proposed method for displaying extended images consumes few computational resources, yet still provides a realistic and informative representation for the vehicle user. This improves safety and driving comfort.

1. A method for displaying extended images of a low front end of a vehicle having a front hood, each extended image comprising an area visible to a user of the vehicle and an area concealed by the front hood of the vehicle, said vehicle being equipped with at least one exterior camera having a field of view oriented towards the low front end of said vehicle, and including said visible area and concealed area, the method being implemented by a computing processor of an on-board programmable electronic device connected to said at least one exterior camera, and comprising the steps of:
estimating a position of the vehicle user's eyes,
processing images captured by said at least one exterior camera to obtain extended images of the low front end of the vehicle, implementing a superimposition, on each image captured by said at least one exterior camera, of a representation of an outline of the front hood of the vehicle, said representation being produced as a function of said position of the eyes of the user of the vehicle, and
displaying said extended images on an on-board display device.

2. The method according to claim 1, wherein said processing implements a calculation of said representation of the outline of the front hood of the vehicle further using previously stored information relating to the model of the vehicle.

3. The method according to claim 1, wherein the position of the user's eyes is predetermined and previously recorded.

4. The method according to claim 1, implemented in a vehicle further comprising an interior camera facing an interior of the vehicle, the estimating of a position of the user's eyes comprising a determining of the position of the user's eyes using images captured by said interior camera.

5. The method according to claim 1, comprising a step of correcting said extended images to obtain corrected extended images prior to the display step, the correction step being configured to transform said field of view of said at least one camera into a user's field of view according to said position of the user's eyes.

6. A non-transitory, computer-readable medium having stored thereon a computer program comprising software instructions which, when executed by a programmable electronic device, implement the method according to claim 1.

7. A system for displaying extended images of a low front end of a vehicle having a front hood, each extended image comprising an area visible to a user of the vehicle and an area concealed by the front hood of the vehicle, said vehicle being equipped with at least one exterior camera having a field of view oriented towards the low front end of said vehicle, and including said visible area and concealed area, the display system comprising said at least one exterior camera, an on-board programmable electronic device connected to said at least one exterior camera, the on-board programmable electronic device comprising a computing processor and an on-board display device, wherein the computing processor is configured to implement:
a module for estimating a position of the vehicle user's eyes,
a module for processing images captured by said at least one camera to obtain extended images of the low front end of the vehicle, implementing a superimposition, on each image captured by said at least one camera, of a representation of an outline (16) of the front hood of the vehicle, said representation being produced as a function of said position of the eyes of the user of the vehicle, and
a module for displaying said extended images on an on-board display device.

8. The system according to claim 7, wherein said processing module implements a calculation of said representation of the outline of the front hood of the vehicle further using previously stored information relating to the model of the vehicle.

9. The system according to claim 7, further comprising an interior camera oriented towards an interior of the vehicle, the module for estimating a position of the user's eyes implementing a determination of the position of the user's eyes using images captured by said interior camera.

10. The system according to claim 7, wherein said on-board display device is a display screen arranged on a dashboard of said vehicle.

11. A vehicle comprising the system according to claim 7.
